(19) United States
(12) Patent Application Publication
(10) Pub. No.: US 2016/0267668 A1
(43) Pub. Date: Sep. 15, 2016

(54) MEASUREMENT APPARATUS

(71) Applicant: CANON KABUSHIKI KAISHA, Tokyo (JP)

(72) Inventor: Akihiro Yamada, Sakura-shi (JP)

(21) Appl. No.: 15/059,484

(22) Filed: Mar. 3, 2016

(30) Foreign Application Priority Data
Mar. 13, 2015 (JP) 2015-051294

(51) Int. Cl. G06T 7/00; G01B 11/25; H04N 9/07

(52) U.S. Cl. CPC G06T 7/0057; G06T 7/0085; G06T 7/0097; G06T 7/0069; H04N 9/07; G01B 11/2509; G06T 2207/10024; G06T 2207/20024; G06T 2207/20048

(57) ABSTRACT

A measurement apparatus includes: an illumination unit configured to illuminate an object to be measured with first light in a first wavelength region and second light in a second wavelength region simultaneously; an image sensing unit including an imaging optical system having an axial chromatic aberration between the two wavelength regions, a wavelength separation filter configured to separate images in the first and second wavelength regions of the object, and an image sensor configured to sense the two images; and a processor. The processor executes deconvolution processing for one of the two images, which has a large amount of defocusing, and obtains information of a shape of the object using the one image having undergone the deconvolution processing and the other one of the two images.

### BACKGROUND OF THE INVENTION

1. Field of the Invention

The present invention relates to a measurement apparatus for measuring the shape of an object to be measured (target object).

2. Description of the Related Art

In recent years, robots increasingly perform complex tasks such as assembly of industrial products, which have been conventionally done by humans. A robot grips parts using an end effector such as a hand, and assembles them. To implement this assembling operation by robots, it is necessary to measure the position and orientation of a part (work) to be gripped. Japanese Patent No. 5393318 discloses a method of measuring the position and orientation of a work by model fitting by simultaneously using measurement information (edge data) obtained from a grayscale image and measurement information (distance point group data) obtained from an image for detecting a distance. In the measurement method described in Japanese Patent No. 5393318, assuming that an error on the grayscale image and an error on the image for detecting the distance comply with different probability distributions, the position and orientation is estimated by maximum likelihood estimation by simultaneously using the errors. Therefore, even if the accuracy is high and the initial condition is poor, the position and orientation can stably be estimated.

If the position and orientation of a work is measured while moving a robot to speed up the assembly process, it is necessary to simultaneously measure the grayscale image and the image for detecting the distance in order to guarantee the field shift between the grayscale image and the image for detecting a distance. As a method of solving this problem, there is known a method disclosed by Japanese Patent No. 5122729. In the measurement method described in Japanese Patent No. 5122729, a work is simultaneously illuminated using an illumination unit for a grayscale image and an illumination unit for an image for detecting a distance, which have different wavelengths, a wavelength separation prism separates the wavelengths, and both images are simultaneously sensed using a sensor for a grayscale image and a sensor for an image for detecting a distance.

Since, however, the measurement method disclosed in Japanese Patent No. 5122729 requires both the sensor for a grayscale image and the sensor for an image for detecting a distance, the following problems arise.

(1) Since a plurality of sensors are necessary, the cost rises.

(2) Since a plurality of sensors need to be arranged, the size of a measurement apparatus becomes large.

(3) Since a grayscale image and an image for detecting a distance are measured by separate sensors, accuracy stability to an alignment error and a temperature variation such as heat generation poses a problem.

To solve the above problems, there is provided a method of measuring the position and orientation of a work by simultaneously measuring a grayscale image and an image for detecting a distance by one camera using a color camera. The color camera can separate light by a color filter formed on each pixel surface. Thus, different wavelengths are respectively applied to obtaining of a grayscale image and obtaining of an image for detecting a distance. For example, an active stereo method of using a wavelength of 650 nm to obtain a grayscale image and using a wavelength of 500 nm to obtain an image for detecting a distance is applied. By using a wavelength of 500 nm to obtain an image for detecting a distance, it is possible to obtain a pattern projection image as an image for detecting a distance in a pixel having sensitivity to blue (450 nm) and a pixel having sensitivity to green (550 nm).

When simultaneously obtaining a grayscale image and an image for detecting a distance using one color camera, spectral characteristics of color filters on the color camera are important. FIG. 1 shows an example of the spectral sensitivities of the color filters on the color camera at each wavelength. Each filter has a broad spectral sensitivity characteristic. For this reason, a light beam of a single wavelength is detected not by one of R, G, and B pixels but by all the pixels at different sensitivities. It is generally difficult to form thick color filters on the color camera. Consequently, it becomes more difficult to improve the spectral performance as the incident angle of a light beam becomes larger. In general, since a light beam entering the color camera is converging light, the light beam partially have a given incident angle. In this way, even if a grayscale image and a pattern projection image are sensed at different wavelengths, both the images are detected in a mixed state in accordance with the spectral sensitivities. Mixing of the grayscale image and the pattern image is called crosstalk.

If a grayscale image and an image for detecting a distance are mixed, and crosstalk occurs, a pattern may erroneously be recognized as an edge, affecting the measurement accuracy. FIG. 2 is a schematic view showing a case in which a grayscale image and a pattern projection image are mixed and crosstalk occurs. A solid line in FIG. 2 indicates the cross section of an ideal grayscale image obtained in pixels corresponding to a red wavelength. By detecting an edge with respect to this image, a correct edge position indicated by □ is obtained. On the other hand, a dotted line in FIG. 2 indicates the cross section of an image in which crosstalk occurs between the grayscale image and the image for detecting the distance in the pixels corresponding to the red wavelength. If an edge is detected with respect to this image, the image for detecting the distance is included in the grayscale image, and a plurality of incorrect edges are recognized (positions indicated by ◯ in FIG. 2). Incorrect edge positions influence at the time of model fitting, thereby causing a large error in the position and orientation.

### SUMMARY OF THE INVENTION

The present invention provides a measurement apparatus for measuring, with high accuracy, the shape of an object to be measured.

The present invention in one aspect provides a measurement apparatus for measuring a shape of an object to be measured, the apparatus comprising: an illumination unit configured to illuminate the object to be measured with first light in a first wavelength region having a pattern shape, and illuminate the object to be measured with second light in a second wavelength region different from the first wavelength region at the same time; an image sensing unit including an imaging optical system having an axial chromatic aberration between the first wavelength region and the second wavelength region, a wavelength separation filter configured to separate an image in the first wavelength region of the object to be measured and an image in the second wavelength region of the object to be measured, and an image sensor configured to sense the image in the first wavelength region and the image in the second wavelength region; and a processor configured to process the first image in the first wavelength region and the second image in the second wavelength region of the object to be measured, which are output from the image sensing unit, wherein the processor executes deconvolution processing for one of the first image and the second image, which has a large amount of defocusing, and obtains information of the shape using the one image having undergone the deconvolution processing and the other one of the first image and the second image.

Further features of the present invention will become apparent from the following description of exemplary embodiments with reference to the attached drawings.

### BRIEF DESCRIPTION OF THE DRAWINGS

FIG. 1 is a graph showing the spectral sensitivity characteristics of wavelength division elements;

FIG. 2 is a schematic view showing the cross section of a grayscale image according to a prior art;

FIG. 3 is a schematic view showing a measurement apparatus;

FIG. 4 is a view showing an example of an array of wavelength separation filters according to the present invention;

FIG. 5 is a view showing an example of part of an image for detecting a distance according to the present invention;

FIG. 6 is a view showing an example of part of a grayscale image according to the present invention;

FIG. 7 is a schematic view showing the cross section of the obtained grayscale image according to the present invention; and

FIGS. 8A to 8C are views for explaining the relationship between a differential filter and an edge position.

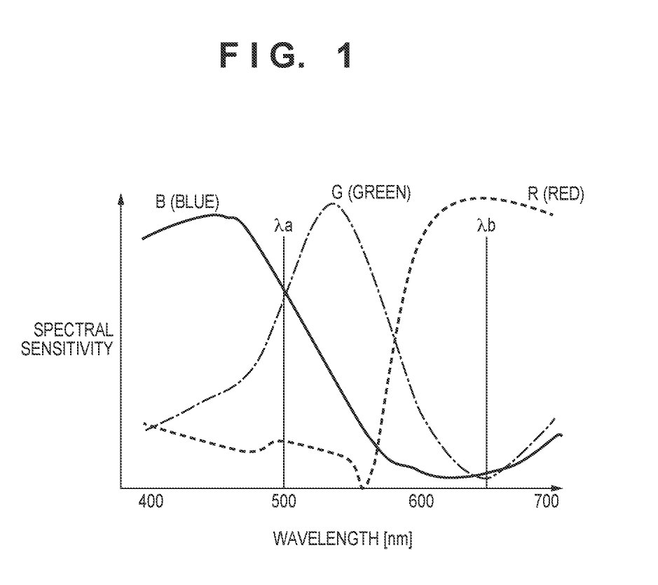

### DESCRIPTION OF THE EMBODIMENTS

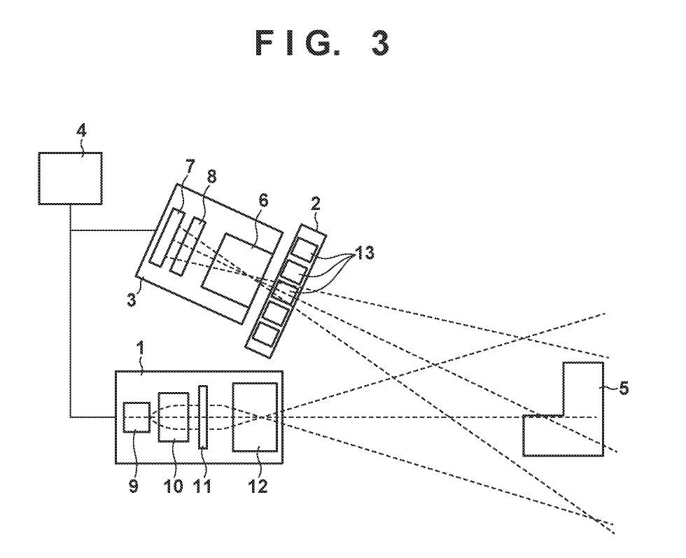

An embodiment of a measurement apparatus according to the present invention will be described in detail below with reference to the accompanying drawings. FIG. 3 shows a measurement apparatus for measuring the position and orientation of an object to be measured by measuring the three-dimensional shape and the two-dimensional shape of the object to be measured according to the present invention. As shown in FIG. 3, the measurement apparatus includes an illumination unit (first illumination unit) 1 for a three-dimensional shape image (image for detecting a distance; first image), an illumination unit (second illumination unit) 2 for a two-dimensional shape image (grayscale image; second image), an image sensing unit 3, and a processor 4. In this embodiment, the illumination unit for the image for detecting the distance and that for the grayscale image are separately formed. However, it is possible to form the illumination unit for the image for detecting the distance and that for the grayscale image in one illumination unit using wavelength separation filters.

The measurement apparatus causes the image sensing unit 3 to simultaneously sense a three-dimensional shape image (an image for detecting a distance) and a second-dimensional shape image (a grayscale image), and causes the processor 4 to perform model fitting using the two images, thereby measuring the position and orientation of a work (object to be measured) 5. Note that the model fitting is performed for a CAD model of the work 5 created in advance and assumes that the three-dimensional shape of the work 5 is known.

An overview of obtaining of an image for detecting a distance and an overview of obtaining of a grayscale image will be described below. Obtaining of an image for detecting a distance will be explained first. An image for detecting a distance is a pattern projection image representing three-dimensional information of points on the surface of the object to be measured, and each pixel has depth information. In obtaining an image for detecting a distance, the first illumination unit 1 illuminates the work 5 with first light in a first wavelength region having a pattern shape, and the image sensing unit 3 senses, from a direction different from that of the first illumination unit 1, an image in the first wavelength region of the work 5 illuminated with the first light. Based on the principle of triangulation, the processor 4 calculates distance information (three-dimensional shape information) from the image (first image) in the first wavelength region of the work 5 output from the image sensing unit 3. In this embodiment, the pattern projected onto the work 5 is a pattern for allowing distance information to be calculated from one image (first image) in the first wavelength region.

An illumination optical system 10 of the first illumination unit 1 uniformly illuminates a mask 11 with a light beam emitted from a light source 9. A pattern shape to be projected onto the work 5 is drawn on the mask 11. The pattern shape is formed by, for example, chromium-plating a glass substrate. The pattern shape of the first light varies depending on a measurement method. The pattern shape of the first light is formed from, for example, dots or slits (lines). When the pattern shape of the first light is formed from dots, the first light may be a single dot or a dot line pattern obtained by arranging a plurality of dots whose coordinates are identifiable on each line of a line pattern. When the pattern shape of the first light is formed from lines, the first light may be slit light formed from one line or a line width modulated pattern obtained by changing the width of each line to identify the line. A projection optical system 12 forms, on the work 5, an image of the pattern shape drawn on the mask 11. Note that in this embodiment, a method of projecting the first light of the pattern shape using the mask 11 fixed within the first illumination unit 1 has been explained. However, the present invention is not limited to this, and the pattern may be projected using a liquid crystal projector or a projector using a digital mirror device (DMD). Furthermore, measurement may be performed while changing the pattern by switching the DMD.

Subsequently, obtaining of the grayscale image (second image) by illuminating the work with second light in a second wavelength region different from the first wavelength region will be described. The grayscale image is a grayscale image sensed by the image sensing unit (camera) 3. In this embodiment, an edge corresponding to the contour or ridge of the object is detected from the grayscale image, and used as an image feature to calculate the position and orientation. To obtain the grayscale image, the image sensing unit 3 senses the work 5 uniformly illuminated by the second illumination unit 2 for the grayscale image. The second illumination unit 2 is ring illumination obtained by arraying a plurality of light sources 13 in a ring, and can uniformly illuminate the work 5 with ring illumination not to form a shadow as much as possible. Note that illumination by the illumination unit 2 is not limited to the ring illumination, and coaxial epi-illumination, dome illumination, or the like may be adopted. The processor 4 calculates the edge of the work 5 by detecting an edge with respect to the obtained grayscale image. As an edge detection algorithm, the Canny method and other various methods are available, and any of them can be used in the present invention.

The image sensing unit 3 will be described. The image sensing unit 3 senses the image for detecting the distance and the grayscale image at the same time. The image sensing unit 3 includes an imaging optical system 6, an image sensor (imaging element) 7, and a wavelength separation filter 8. The imaging optical system 6 is an optical system for forming, on the image sensor 7, an image of the pattern projected onto the work 5. In this embodiment, the second illumination unit 2 and the first illumination unit 1 illuminate the work 5 in the two different wavelength regions, and the image sensing unit 3 includes the wavelength separation filter 8 for assigning one of blue, green, and red to each pixel of the image sensor 7. Therefore, the image sensing unit 3 according to this embodiment separates the image for detecting the distance and the grayscale image according to the wavelength regions, and separates them into an image of pixels in the two wavelength regions and an image of pixels in one wavelength region. That is, two images of the image for detecting the distance and the grayscale image are simultaneously obtained by the one image sensor 7 using the wavelength division function of the color image sensor 7. The image sensor 7 is an element for sensing the image for detecting the distance and, for example, a CMOS sensor, a CCD sensor, or the like can be used.

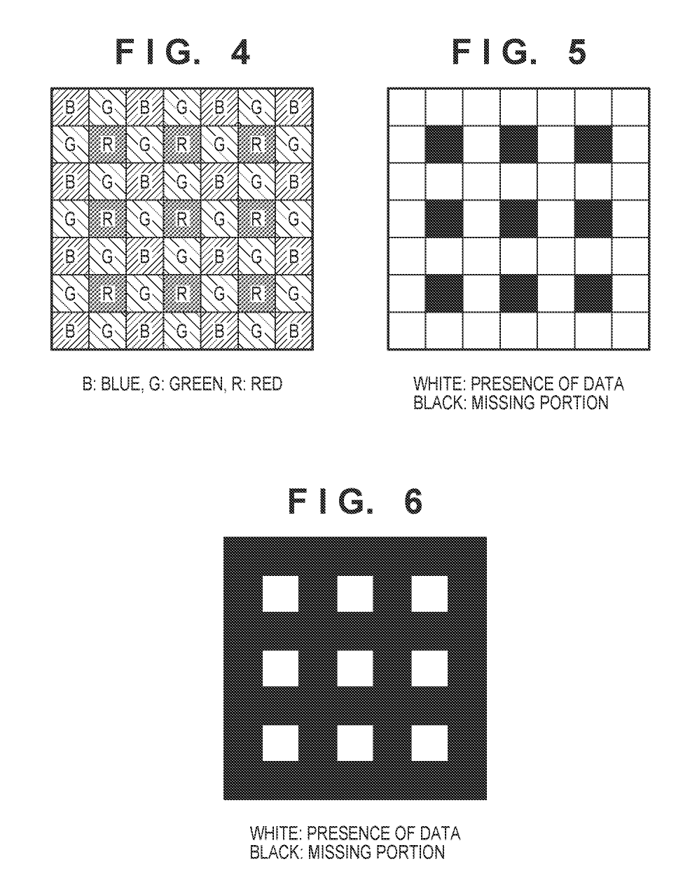

The image sensor 7 is a color image sensor, and the wavelength separation filter 8 assigns one of blue, green, and red to each pixel. For example, a Bayer color filter shown in FIG. 4 is used as the wavelength separation filter 8. The Bayer color filter has an array, shown in FIG. 4, whose ratio of blue, green, and red is 1:2:1. Referring to FIG. 4, B transmits light in the blue wavelength band, G transmits light in the green wavelength band, and R transmits light in the red wavelength band. The present invention is not limited to this, and another pixel arrangement may be used. For example, the color filter may assign one of blue and red to each pixel and has an array whose ratio of blue and red is 1:1.

To simultaneously measure the image for detecting the distance and the grayscale image, it is necessary to assign the two images to pixels of three B, G, and R wavelengths. In order not to lose an information amount as much as possible, it is possible to assign the pixels of two wavelengths to one of the pattern projection image and grayscale image, and assign the pixels of the remaining one wavelength to the other. In this embodiment, the pixels corresponding to the blue and green wavelengths are used to sense the pattern projection image and the pixels corresponding to the red wavelength are used to sense the grayscale image.

If an image is obtained using only the pixels corresponding to the blue and green wavelengths, a sensed image (a pattern projection image for calculation of the image for detecting the distance) is obtained as an image in which the pixels corresponding to the red wavelength are missing, as shown in FIG. 5. On the other hand, if an image is obtained using only the pixels corresponding to the red wavelength, a sensed image (grayscale image) is obtained as an image in which the pixels corresponding to the blue and green wavelengths are missing, as shown in FIG. 6. Therefore, in this embodiment, a missing portion is interpolated (demosaicing processing) using the luminance values of surrounding pixels, thereby generating an image having a resolution equal to the original resolution. A method of calculating the position and orientation from the respective images can be implemented, similarly to the conventional example.

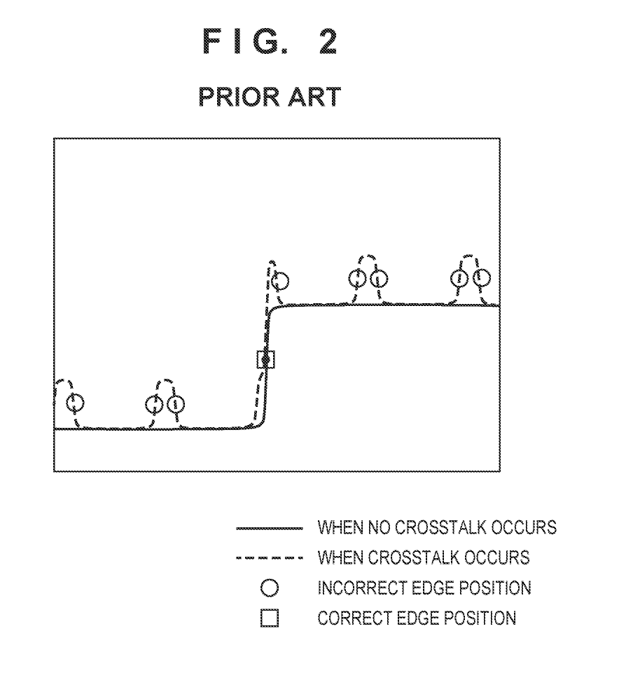

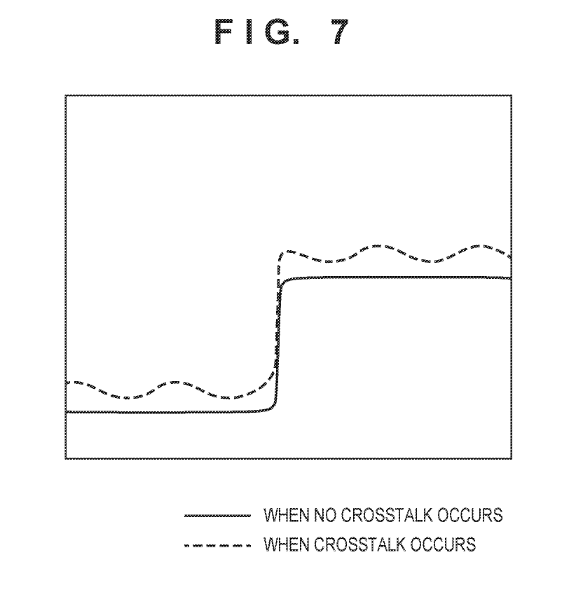

In this embodiment, an optical system having an axial chromatic aberration between the first and second wavelength regions is applied to the imaging optical system 6, and the color image sensor 7 is arranged at or near the focus position of a wavelength at which the grayscale image is obtained. As a result, the image for detecting the distance is obtained as an image having a large amount of defocusing, that is, a blurred image due to the axial chromatic aberration of the imaging optical system 6. FIG. 7 is a schematic view showing a case in which the grayscale image and the image for detecting the distance are mixed and crosstalk occurs. Similarly to the solid line in FIG. 2, a solid line in FIG. 7 indicates the cross section of the grayscale image when no crosstalk occurs between the grayscale image and the image for detecting the distance. A dotted line in FIG. 7 indicates the cross section of the grayscale image when crosstalk occurs between the grayscale image and the image for detecting the distance. With respect to the dotted line in FIG. 2, the dotted line in FIG. 7 is included as a blurred image since the image for detecting the distance is deviated from the focus position.

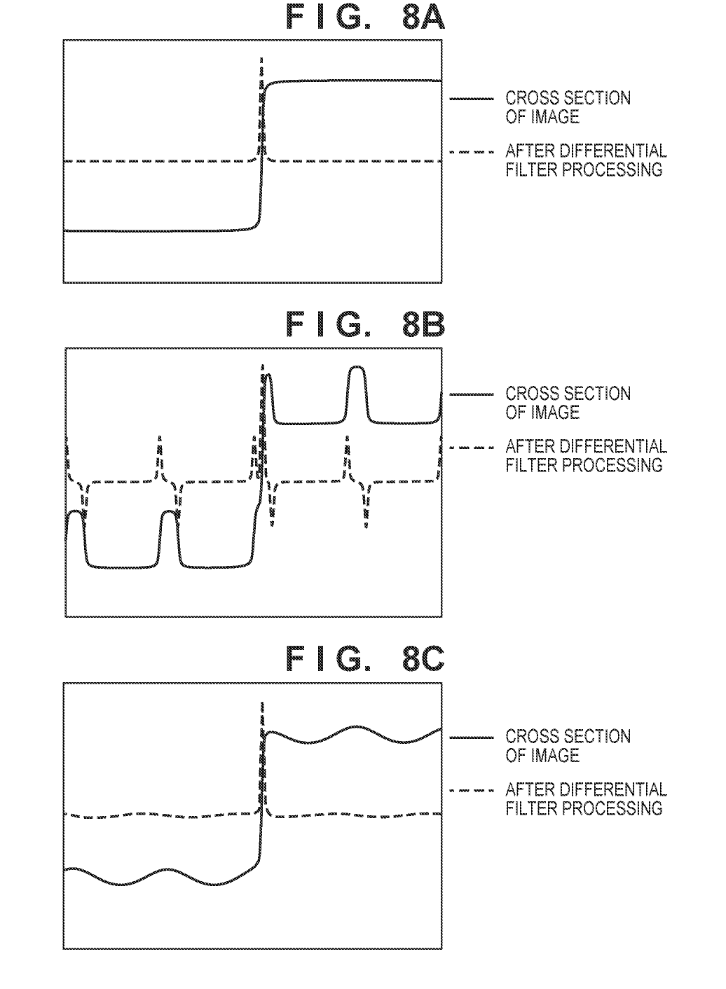

When detecting an edge with respect to the image indicated by the dotted line in FIG. 7, it is possible to detect only a correct edge position by performing threshold determination. In threshold determination, for example, the positions of extreme values when a differential filter is applied to the obtained grayscale image correspond to edge positions but a threshold is set for the extreme values, and the extreme values equal to or smaller than the threshold are not considered as edges. FIGS. 8A to 8C are sectional views each showing an image obtained by applying the differential filter to each of the images shown in FIGS. 2 and 7. FIG. 8A is a view showing an image obtained by executing differential processing for the image indicated by the solid line in FIG. 2 or 7. It is understood that the extreme value of the image having undergone the differential processing coincides with the edge position.

FIG. 8B is a view showing an image obtained by performing differential processing for the image indicated by the dotted line in FIG. 2. In the image having undergone the differential processing, extreme values occur due to the pattern image of the image for detecting the distance also included in a portion except for a correct edge position portion. FIG. 8C is a view showing an image obtained by performing differential processing for the image indicated by the dotted line in FIG. 7. As compared with the image shown FIG. 8B, in the image shown in FIG. 8C, the extreme value of the image having undergone the differential processing occurs at the correct edge position while the image for detecting the distance is blurred at pseudo edge positions caused by the image for detecting the distance. Therefore, the image has the extreme values at the pseudo edge positions but the extreme values are very small. Consequently, it is possible to readily determine pseudo edges by threshold determination. Note that if the threshold for the extreme values is set too large so as to eliminate pseudo edges caused by the image for detecting the distance in FIG. 8B, the correct edge position is also unwantedly eliminated.

The image for detecting the distance is obtained by the color image sensor 7 deviated from the focus position, resulting in a blurred image. With respect to this blurred image for detecting the distance, the processor 4 performs image recovery to obtain a sharp image. Image recovery indicates, for example, execution of deconvolution processing. An example of the deconvolution processing is a method of Fourier-transforming the obtained image for detecting the distance, executing recovery processing for each frequency, and performing inverse Fourier transform. Furthermore, a method of simply applying a deconvolution filter and a method of applying an edge recovery filter are available. However, the deconvolution processing is not specifically limited to them.

The measurement apparatus has a range of a depth of filed for ensuring the position measurement accuracy. Thus, in this embodiment, for example, the axial chromatic aberration of the imaging optical system 6 satisfies inequality (1) below. Let ΔF be the difference between the focus position of the first light and that of the second light of the imaging optical system 6, that is, the axial chromatic aberration between the first and second wavelength regions.

ΔF>DOF×β² (1)

where DOF represents the depth of filed guaranteed by the measurement apparatus, and β represents the paraxial magnification of the imaging optical system 6.

When the axial chromatic aberration ΔF of the imaging optical system 6 satisfies inequality (1), the focus position at which the image contrast of the image for detecting the distance is highest falls outside the range of the depth of field of the grayscale image. The image for detecting the distance can be a pattern image having a periodic structure. If the image for detecting the distance is a periodic pattern image, when it is deviated from the focal point and blurs, it has uniform strength. Therefore, the blurred image for detecting the distance which is included in the grayscale image has uniform strength, thereby making it difficult to obtain pseudo edges. On the other hand, if the image for detecting the distance is an aperiodic pattern image, when it is deviated from the focal point, the strength is high at a position where the pattern density is high and the strength is low at a position where the pattern density is low. Consequently, if the image for detecting the distance is an aperiodic pattern image, unevenness in strength may cause pseudo edges.

Furthermore, in fact, the grayscale image is unwantedly included in the image for detecting the distance due to the spectral characteristics of the color filters. As a measure against this, when performing image recovery of the image for detecting the distance, it is possible to recover only a specific frequency component of the image for detecting the distance. The specific frequency component is the fundamental frequency of the pattern of the image for detecting the distance, and indicates a frequency corresponding to a pattern pitch. As described above, by applying the imaging optical system 6 having the axial chromatic aberration to obtain an arrangement in which the grayscale image and the image for detecting the distance have different focus positions, it becomes possible to reduce an edge detection error caused by the spectral characteristics of the color filters of the image sensor 7.

In this embodiment, the image for detecting the distance has a large amount of defocusing. However, it is possible to reduce crosstalk between the two images by making the amount of defocusing of the grayscale image large, instead of the image for detecting the distance. Furthermore, image recovery may be performed for both the image for detecting the distance and the grayscale image which have defocused.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-051294, filed Mar. 13, 2015, which is hereby incorporated by reference herein in its entirety.

What is claimed is:

1. A measurement apparatus for measuring a shape of an object to be measured, the apparatus comprising:
an illumination unit configured to illuminate the object to be measured with first light in a first wavelength region having a pattern shape, and illuminate the object to be measured with second light in a second wavelength region different from the first wavelength region at the same time;
an image sensing unit including an imaging optical system having an axial chromatic aberration between the first wavelength region and the second wavelength region, a wavelength separation filter configured to separate an image in the first wavelength region of the object to be measured and an image in the second wavelength region of the object to be measured, and an image sensor configured to sense the image in the first wavelength region and the image in the second wavelength region; and
a processor configured to process the first image in the first wavelength region and the second image in the second wavelength region of the object to be measured, which are output from the image sensing unit,
wherein the processor executes deconvolution processing for one of the first image and the second image, which has a large amount of defocusing, and obtains information of the shape using the one image having undergone the deconvolution processing and the other one of the first image and the second image.

2. The apparatus according to claim 1,
wherein when ΔF represents the axial chromatic aberration of the imaging optical system, DOF represents a depth of field of the measurement apparatus, and β represents a paraxial magnification of the imaging optical system, ΔF satisfies a relationship of ΔF>DOF×β².

3. The apparatus according to claim 1,
wherein the illumination unit includes a first illumination unit configured to illuminate the object to be measured with the first light, and a second illumination unit configured to illuminate the object to be measured with the second light.

4. The apparatus according to claim 1,
wherein the image sensor is arranged so that a distance from a focus position in the first wavelength region of the imaging optical system is longer than a distance from a focus position in the second wavelength region of the imaging optical system, and
wherein the processor executes deconvolution processing for the first image, obtains information of a three-dimensional shape of the object to be measured using the first image having undergone the deconvolution processing, and obtains information of a two-dimensional shape of the object to be measured using the second image.

5. The apparatus according to claim 4,
wherein the image sensor is arranged at the focus position in the second wavelength region of the imaging optical system.

6. The apparatus according to claim 4,
wherein the processor executes differential processing for the second image, and obtains information of the two-dimensional shape using the second image having undergone the differential processing.

7. The apparatus according to claim 4,
wherein the pattern shape has a periodic structure.

8. The apparatus according to claim 7,
wherein the processor executes deconvolution processing for a frequency component of the pattern shape in the first image.

9. The apparatus according to claim 3,
wherein the second illumination unit performs one of an operation of illuminating the object to be measured with ring lights, an operation of giving coaxial epi-illumination to the object to be measured, and an operation of illuminating the object to be measured with dome lights.

10. The apparatus according to claim 1,
wherein light in the first wavelength region includes light in a blue wavelength band and light in a green wavelength band, and light in the second wavelength region includes light in a red wavelength band, and
wherein the wavelength separation filter is a Bayer color filter.

11. The apparatus according to claim 1,
wherein the processor Fourier-transforms the one image, executes recovery processing for the Fourier-transformed image for each frequency, and executes deconvolution processing by performing inverse Fourier processing for the image having undergone the recovery processing.

12. The apparatus according to claim 1,
wherein the processor includes one of a deconvolution filter and a filter which recovers an edge of the one image.
